(19) United States
(12) Patent Application Publication
(10) Pub. No.: US 2025/0350764 A1
(43) Pub. Date: Nov. 13, 2025

(54) Geometry Conversion to Dense Geometry Format

(71) Applicant: Advanced Micro Devices, Inc., Santa Clara, CA (US)

(72) Inventors: Joshua Barczak, Forest Hill, MD (US); Mohammed Ahmed Muneam Al-Obaidi, St. Albans (GB); David Kirk McAllister, Holladay, UT (US); Trevor Hedstrom, San Diego, CA (US)

(21) Appl. No.: 19/087,851

(22) Filed: Mar. 24, 2025

Related U.S. Application Data
(60) Provisional application No. 63/646,287, filed on May 13, 2024.

(51) Int. Cl. H04N 19/597; G06T 15/06; G06V 10/25; H04N 19/176

(52) U.S. Cl. CPC H04N 19/597; G06T 15/06; G06V 10/25; H04N 19/176

(57) ABSTRACT

Systems and methods described herein for encoding primitive data into one or more fixed-size data blocks. Raw and unencoded primitives are quantized and clustered into SAH-based clusters. From any given cluster, a first primitive is arbitrarily chosen and vertex data for the primitive is encoded using a first fixed size block. A second primitive is then selected, and a determination is made whether both the first and second primitive can be encoded using the first fixed-size block. If possible, the first primitive and the second primitive is encoded using the first fixed size block. However, if the data for the two primitives cannot fit in the first fixed size block, the second primitive is used to create a second new fixed size block, or data corresponding to the second primitive is stored using an existing fixed size block different than the first fixed size block.

### CROSS REFERENCE TO RELATED APPLICATIONS

This application claims priority to Provisional Patent Application Ser. No. 63/646,287 entitled “Geometry Conversion to DGF” filed May 13, 2024, the entirety of which is incorporated herein by reference.

### BACKGROUND

### Description of the Related Art

Ray tracing involves simulating how light moves through a scene using a physically-based rendering approach. Although it has been extensively used in cinematic rendering, it was previously deemed too demanding for real-time applications until recently. A critical aspect of ray tracing is the computation of visibility for ray-scene intersections, achieved through a process called “ray traversal.” This involves calculating intersections between rays and scene objects by navigating through and intersecting nodes organized in a bounding volume hierarchy (BVH).

Standard methods for performing ray tracing or rasterization operations usually involve executing a graphics processing pipeline consisting of a series of stages dedicated to graphics operations. For instance, during each stage of this pipeline, a GPU can carry out various graphics-oriented processing tasks. At one stage, the GPU might gather a collection of geometrical primitives that depict a graphics scene, and in a subsequent stage, it could execute shading operations using the vertices linked to those primitives. Ultimately, the GPU would convert these vertices into pixels through a process known as rasterization, thereby rendering the graphics scene.

In ray tracing, encoding raw primitive data efficiently is crucial for performance and memory optimization. Primitive data, such as triangles, spheres, or other geometric shapes, must be stored in a format that enables fast traversal and intersection testing. Typically, this involves using compact binary structures to represent vertex positions, normals, texture coordinates, and material properties. Acceleration structures like Bounding Volume Hierarchies (BVH) or kd-trees rely on optimized encoding to facilitate efficient spatial partitioning and minimize traversal overhead. Additionally, data compression techniques, such as quantization help reduce memory footprint while preserving precision. GPU-based ray tracers further optimize primitive encoding by aligning data structures to match SIMD-friendly layouts, ensuring optimal cache utilization and minimizing memory bandwidth bottlenecks.

Encoding primitive data for ray tracing may present several challenges that impact both performance and accuracy. One major issue is precision loss, especially when using compressed or quantized representations for vertex positions and normals, which can introduce artifacts in rendering. Memory alignment and cache inefficiencies also pose problems, as poorly structured data can lead to increased memory bandwidth usage and slow traversal. Another challenge is balancing storage and computation, where minimizing memory footprint through compact encoding can increase the computational cost of decoding during ray intersection tests. Additionally, handling different primitive types-such as triangles, spheres, or implicit surfaces-requires flexible data structures that may introduce branching inefficiencies. Suboptimal encoding can lead to unstructured memory access patterns, reducing SIMD efficiency and causing performance bottlenecks in high-performance ray tracing pipelines.

In view of the above, improved systems and methods for encoding primitive data are needed.

### BRIEF DESCRIPTION OF THE DRAWINGS

The advantages of the methods and mechanisms described herein may be better understood by referring to the following description in conjunction with the accompanying drawings, in which:

FIG. 1 is a block diagram of one implementation of a computing system.

FIG. 2 illustrates the details of the computing system.

FIG. 3 is an illustration of a bounding volume hierarchy (BVH), according to an implementation.

FIG. 4 is a block diagram illustrating encoding of primitive data for generation of acceleration structures.

FIG. 5 illustrates a Dense Geometry Format (DGF) data block.

FIGS. 6a to 6c illustrate a process of encoding triangle data using DGF blocks.

FIGS. 7a and 7b illustrate a process of selecting triangles to be encoded using DGF blocks.

FIG. 8 illustrates a method for encoding primitive data using DGF blocks.

### DETAILED DESCRIPTION OF IMPLEMENTATIONS

In the following description, numerous specific details are set forth to provide a thorough understanding of the methods and mechanisms presented herein. However, one having ordinary skill in the art should recognize that the various implementations may be practiced without these specific details. In some instances, well-known structures, components, signals, computer program instructions, and techniques have not been shown in detail to avoid obscuring the approaches described herein. It will be appreciated that for simplicity and clarity of illustration, elements shown in the figures have not necessarily been drawn to scale. For example, the dimensions of some of the elements may be exaggerated relative to other elements.

Systems, apparatuses, and methods for encoding geometrical primitives efficiently into data blocks are disclosed herein. To create the data blocks, quantized vertex data corresponding to geometric primitives are clustered and each cluster is decomposed into one or more DGF blocks. Each cluster is encoded independently to maximize vertex re-use. In any given cluster, the first primitive is arbitrarily selected to start a new DGF block. A next primitive is iteratively selected from available unused primitives. The selection is based on the primitive sharing a maximum number of vertices with the previously encoded primitives in the DGF block. In an event of multiple candidate primitives sharing the same number of vertices with the already encoded primitives, a tie can be broken by comparing Morton codes and choosing the candidate primitive with the lowest Morton code. Once a primitive is selected, the system attempts to encode the current primitive set using the DGF block. When number of bits required to encode the current set is lesser than a current unused number of bits in the DGF block, the selected primitive is retained and another primitive in the cluster is searched for. However, if number of bits required to encode the current set is greater than the current unused bits, a new DGF block is started, beginning with the selected primitive. This process repeats until all primitives are consumed in the cluster and/or till a DGF block is full. A total number of bits available in a given DGF block can be defined based on the size of the DGF block.

The implementations described herein enable compact storage of large mesh models in a form that minimizes constraints on the content authoring, and enables direct rendering using encoded primitive data. In one implementation, different types of primitive meshes can be represented using the fixed-size data blocks, such that content creators are given fine-grained control over the compression rate to enable tradeoffs between accuracy and storage costs. Further, the encoded data is stored in a manner that the data is amenable for direct consumption by fixed-function hardware (as opposed to compute-shader based rendering). Further, the compression and storage of data disclosed herein enables lossy compression with precise control over data loss and direct rendering of the compressed representation of primitive data.

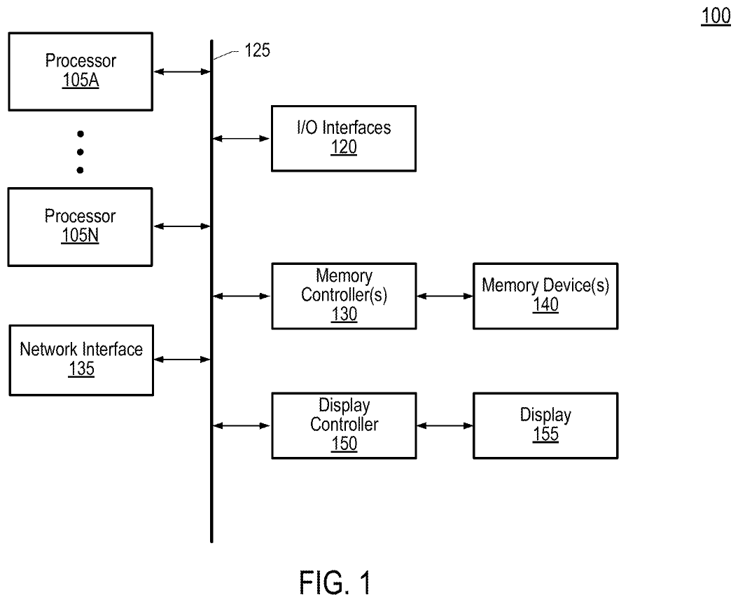

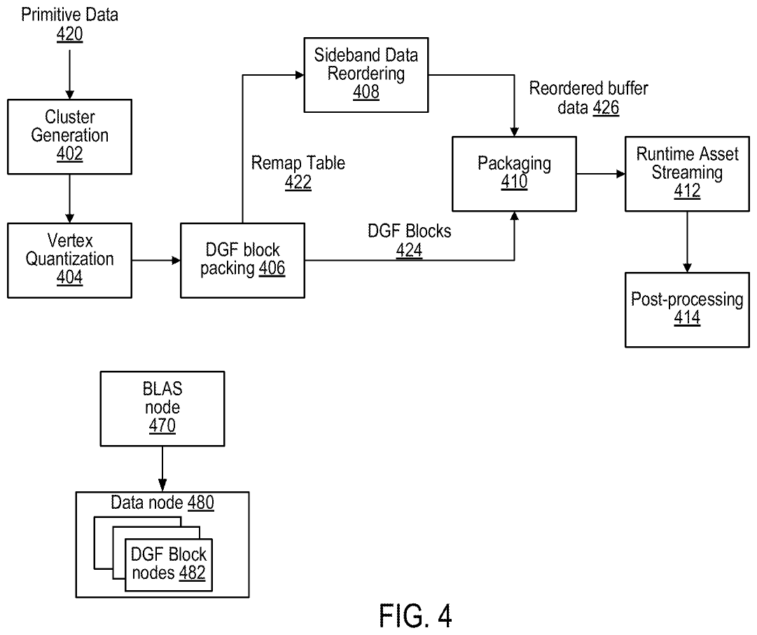

Referring now to FIG. 1, a block diagram of one implementation of a computing system 100 is shown. In one implementation, computing system 100 includes at least processors 105A-N, input/output (I/O) interfaces 120, bus 125, memory controller(s) 130, network interface 135, memory device(s) 140, display controller 150, and display 155. In other implementations, computing system 100 includes other components and/or computing system 100 is arranged differently. Processors 105A-N are representative of any number of processors which are included in system 100. In several implementations, one or more of processors 105A-N are configured to execute a plurality of instructions to perform functions as described with respect to FIGS. 4-8 herein.

In one implementation, processor 105A is a general purpose processor, such as a central processing unit (CPU). In one implementation, processor 105N is a data parallel processor with a highly parallel architecture. Data parallel processors include graphics processing units (GPUs), digital signal processors (DSPs), field programmable gate arrays (FPGAs), application specific integrated circuits (ASICs), and so forth. In some implementations, processors 105A-N include multiple data parallel processors. In one implementation, processor 105N is a GPU which provides pixels to display controller 150 to be driven to display 155.

Memory controller(s) 130 are representative of any number and type of memory controllers accessible by processors 105A-N. Memory controller(s) 130 are coupled to any number and type of memory devices(s) 140. Memory device(s) 140 are representative of any number and type of memory devices. For example, the type of memory in memory device(s) 140 includes Dynamic Random Access Memory (DRAM), Static Random Access Memory (SRAM), NAND Flash memory, NOR flash memory, Ferroelectric Random Access Memory (FeRAM), or others.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, network interface cards, and so forth. Network interface 135 is used to receive and send network messages across a network.

In various implementations, computing system 100 is a computer, laptop, mobile device, game console, server, streaming device, wearable device, or any of various other types of computing systems or devices. It is noted that the number of components of computing system 100 varies from implementation to implementation. For example, in other implementations, there are more or fewer of each component than the number shown in FIG. 1. It is also noted that in other implementations, computing system 100 includes other components not shown in FIG. 1. Additionally, in other implementations, computing system 100 is structured in other ways than shown in FIG. 1.

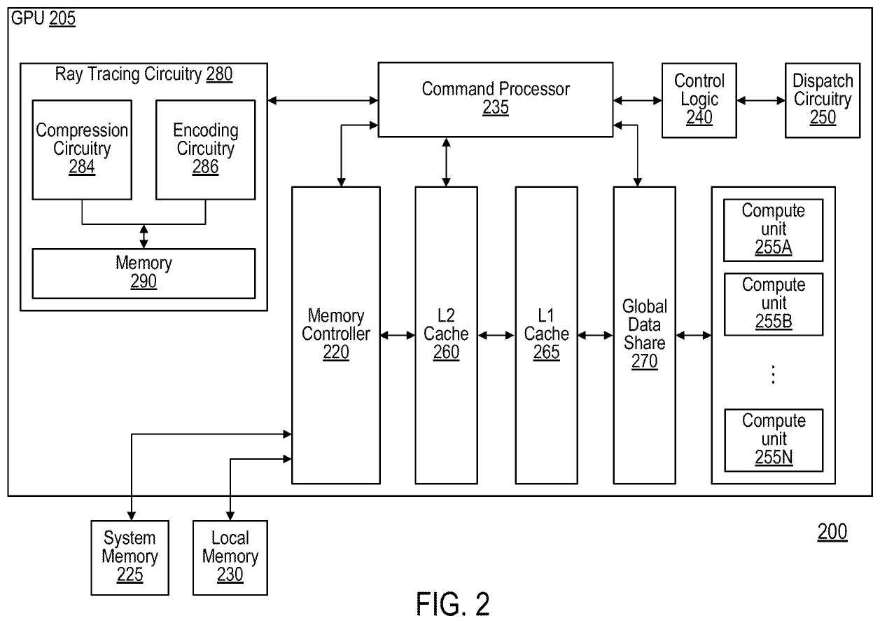

Turning now to FIG. 2, a block diagram of another implementation of a computing system 200 is shown. In one implementation, system 200 includes GPU 205, system memory 225, and local memory 230. System 200 also includes other components which are not shown to avoid obscuring the figure. GPU 205 includes at least command processor 235, control logic 240, dispatch unit 250, compute units 255A-N, memory controller 220, global data share 270, level one (L1) cache 265, and level two (L2) cache 260. In other implementations, GPU 205 includes other components, omits one or more of the illustrated components, has multiple instances of a component even if only one instance is shown in FIG. 2, and/or is organized in other suitable manners. In one implementation, the circuitry of GPU 205 is included in processor 105N (of FIG. 1). System 200 further includes ray tracing circuitry 280 including compression circuitry 284, encoding circuitry 286, and memory 290. Ray tracing circuitry 280 as described herein refers to specialized hardware components or dedicated processing units designed to accelerate ray tracing which is a rendering technique used in computer graphics to generate highly realistic images by simulating the behavior of light. Although shown as integral to the GPU 205, in one or implementations, the ray tracing circuitry 280 can also be a standalone hardware unit. These implementations are contemplated.

In various implementations, computing system 200 executes any of various types of software applications. As part of executing a given software application, a host CPU (not shown) of computing system 200 launches kernels to be performed on GPU 205. Command processor 235 receives kernels from the host CPU and uses dispatch unit 250 to issue corresponding wavefronts to compute units 255A-N. Wavefronts executing on compute units 255A-N read and write data to global data share 270, L1 cache 265, and L2 cache 260 within GPU 205. Although not shown in FIG. 2, in one implementation, compute units 255A-N also include one or more caches and/or local memories within each compute unit 255A-N.

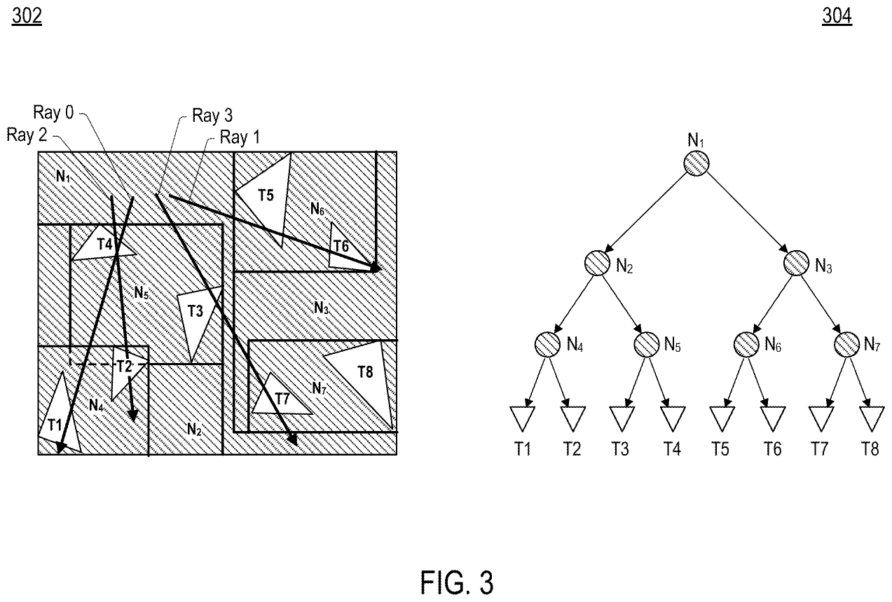

In one implementation, ray tracing circuitry 280 is configured to perform ray tracing operations using an acceleration tree structure (e.g., a bounding volume hierarchy or BVH), including testing for intersection between light rays and objects in a scene geometry. In some implementations, much of the work involved in ray tracing is performed by programmable shader programs, executed on the compute units 255A-N. The ray intersection test fires a ray from an originating source, determines if the ray intersects a geometric primitive (e.g., triangles, implicit surfaces, or complex geometric objects), and if so, determines the distance from the origin to the intersection of the triangle. In an implementation, ray tracing tests use a spatial representation of nodes, such as those includes in the acceleration structure. For instance, in a BVH, each non-leaf node represents an axis-aligned bounding box that bounds the geometry of all children of that node. In one example, a root node represents the maximum extent over the area over which the ray intersection test is being performed. For instance, the root node can have child nodes, each representing a bounding box that typically divides the overall area. Each of these two child nodes can further have child nodes also representing bounding boxes. Leaf nodes represent triangles or other geometric primitives on which ray intersection tests are performed (described in FIG. 3).

Further, in an implementation, based on the tracing of rays within a scene geometry, acceleration structures are formed by command processor 235 and are stored in system memory 225 and/or local memory 230. A tree is loaded onto a memory, and the command processor 235 further executes optimizations on the hierarchical tree. Once a given acceleration structure is optimized, ray intersection tests are performed again and the ray tracing circuitry 280 uses the optimized structure to retest ray intersections in a given scene geometry. These tests are used by shader programs running on the compute units 255A-N to generate images using ray tracing accelerated by the optimized structure. The updated images are then queued for display by command processor 235.

In one implementation, triangle mesh models can be utilized for building acceleration structures, such as bounding volume hierarchies (BVHs) or spatial partitioning grids. When using these mesh models, geometric data is gathered that defines a triangle mesh model. This data can include vertex positions, vertex normals (vectors associated with a vertices of a 3D mesh), texture coordinates, and connectivity information (defining triangles by vertex indices). Each triangle in the mesh is then defined by three vertices and may optionally include other attributes like normals and texture coordinates. For each triangle, additional data like a bounding box or bounding sphere can be computed to quickly assess its spatial extent. For example, a bounding volume (typically an AABB-axis-aligned bounding box) for each triangle in the mesh can be computed. The bounding box encapsulates the triangle's spatial extent, providing a quick way to determine potential intersections without needing to check every triangle individually.

The triangles in the mesh can be sorted or partitioned to spatially organize the triangles to build the acceleration structure efficiently. Common approaches can include using spatial grids or hierarchical structures (like BVHs). Further, depending on the chosen acceleration structure, the hierarchy or grid-based structure is created using the sorted or partitioned triangles. In one example, for constructing BVHs, a recursive partitioning process is initiated, where triangles are split into groups based on a chosen splitting heuristic (e.g., median split, or surface area heuristic). A tree structure is then constructed, wherein each node represents a bounding volume enclosing a subset of triangles. In a BVH, the leaf nodes directly store references to individual triangles.

In some implementations, optimization techniques can be applied during structure construction to enhance traversal and intersection performance. For example, optimal split planes or grid cell sizes can be chosen based on scene statistics. Further, memory layout can be optimized for efficient cache usage during traversal. Once the acceleration structure is built, supplemental processing may also be performed. This can involve refining the structure, balancing tree nodes, or storing additional data (like precomputed normals or material properties) to expedite ray tracing computations.

In one or more implementations, large triangle mesh models can substantially increase rendering times in ray tracing due to the complexity of intersecting rays with detailed geometry. Ray-object intersection tests must be performed for each ray and potentially against numerous triangles, leading to higher computational demands. Large triangle mesh models further require significant memory resources to store and process during ray tracing. Memory-intensive data structures (such as acceleration structures) are needed to organize and efficiently access the mesh data during ray-object intersection calculations. Ray tracing methods may also require additional memory for storing intermediate results (like ray origins, directions, and shading information) during rendering.

Traditional models used in processing mesh models for building acceleration structures can therefore cause negative impacts on content authoring in ray tracing, since these models do not provide for compact storage of large triangle meshes. Further, since ray tracing often involves processing large amounts of geometric and shading data, including vertices, normals, texture coordinates, and material properties, this data can be voluminous, especially for complex scenes with detailed geometry. Traditional compression techniques can also fail to preserve the necessary precision of geometric and shading data to avoid visual artifacts or inaccuracies in the rendered image. Further, these methods introduce overhead in terms of decompression time and memory usage. Compression techniques that disrupt sequential access patterns or require decompressing large blocks of data at once can be inefficient for real-time rendering. Furthermore, lossy compression techniques sacrifice data fidelity to achieve higher compression ratios. While this might be acceptable for certain types of data (e.g., textures), it can be problematic for geometric data where precision is critical.

In implementations described herein, encoding geometric primitives efficiently into fixed-size data blocks, hereinafter referred to as Dense Geometry Format or DGF blocks (e.g., data blocks of 128 bytes) is disclosed. In an implementation, these blocks can be directly consumed by processing circuitry (e.g., GPU 205) for ray traversal or rasterization. To create the DGF blocks, vertex data, before storage in a given block, is pre-quantized by the compression circuitry 284, and encoded by encoding circuitry 286, e.g., using a quantization grid.

In one implementation, encoded vertex data and other triangle data is stored as primitive meshes. In the context of ray tracing, a primitive mesh (e.g., triangle mesh) refers to a collection of primitives that represent a 3D surface or object, specifically tailored for rendering using ray tracing techniques. The primitive mesh data includes a set of vertices, where each vertex is defined by its 3D position and additional attributes like normals, texture coordinates, or colors (as described above). The mesh is composed of primitives, where each primitive is defined by indices pointing to the vertex data. For example, triangle meshes are often stored using optimized data structures like bounding volume hierarchies (BVHs) or KD-trees. These structures organize the triangles spatially to accelerate ray-triangle intersection tests.

It is noted that the implementations described herein refer to triangle meshes, however, data corresponding to other primitive mesh types can be encoded using similar techniques. In one implementation, triangle mesh connectivity data is encoded by encoding circuitry 286 using quantized vertex data for triangles that are clustered using a surface area heuristic (SAH). In this implementation, the compression circuitry 284 compresses vertices in each cluster, e.g., using a signed fixed-point grid (as described later with respect to FIG. 4).

After vertex quantization, the encoding circuitry 286 decomposes each cluster into one or more DGF blocks. The encoding circuitry 286 encodes each cluster independently, e.g., using a greedy algorithm that tries to maximize vertex re-use. In any given cluster, the first triangle is arbitrarily selected to start a new DGF block. The encoding circuitry 286 searches for an unused triangle that shares the maximum number of vertices with the first triangle in the given cluster. As used herein “maximum number of vertices shared between primitives” refers to a largest possible set of identical vertex positions that multiple basic primitives such as triangles or polygons can reference at the same time, without duplicating those vertices in memory or in a data structure. In an event of multiple candidate triangles sharing the same number of vertices with the first triangle, the encoding circuitry 286 is configured to break a tie is by comparing Morton codes of triangle centroids and choosing the candidate triangle with the lowest Morton code.

As described herein, Morton codes, also known as Z-order curves, are used for encoding of multi-dimensional data into a one-dimensional representation while preserving spatial locality. In one example, for a point in a 2D or 3D space, a Morton code is obtained by converting each coordinate into its binary form, interleaving the bits of these binary values, and concatenating the bits to generate a single integer representing the Morton code. In computational geometry and graphics rendering, particularly in bounding volume hierarchies (BVH) or spatial partitioning trees, the selection of triangles (or other geometric primitives) may require an ordering criterion when multiple candidates exist with the same priority. Morton codes are commonly used as a deterministic tie-breaker due to their ability to impose a strict and spatially coherent ordering. In the implementations described herein, when two triangles are compared, each triangle's centroid is computed, and the spatial coordinates of the centroid are transformed into a Morton code. The triangle with the smaller Morton code is selected in case of a tie.

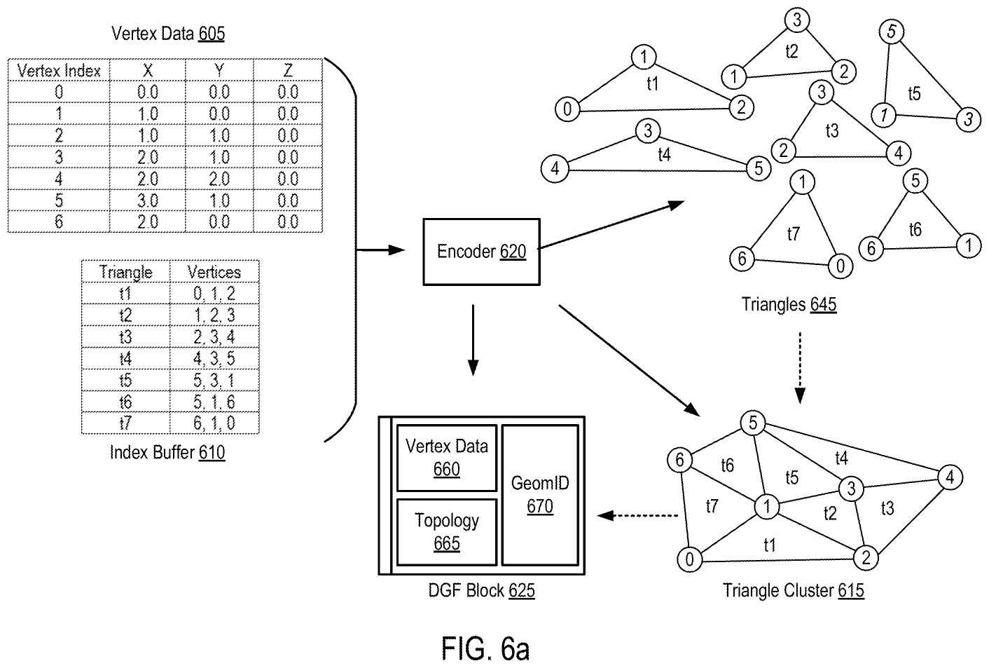

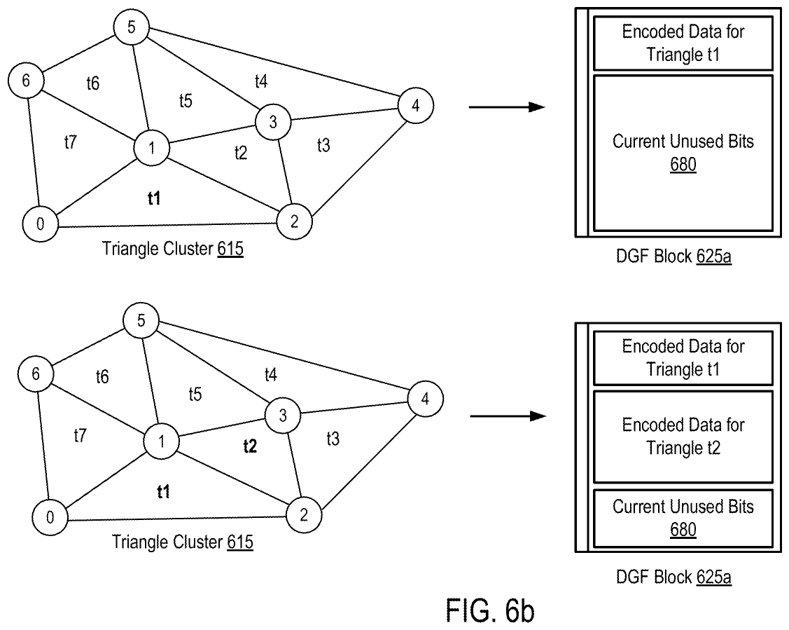

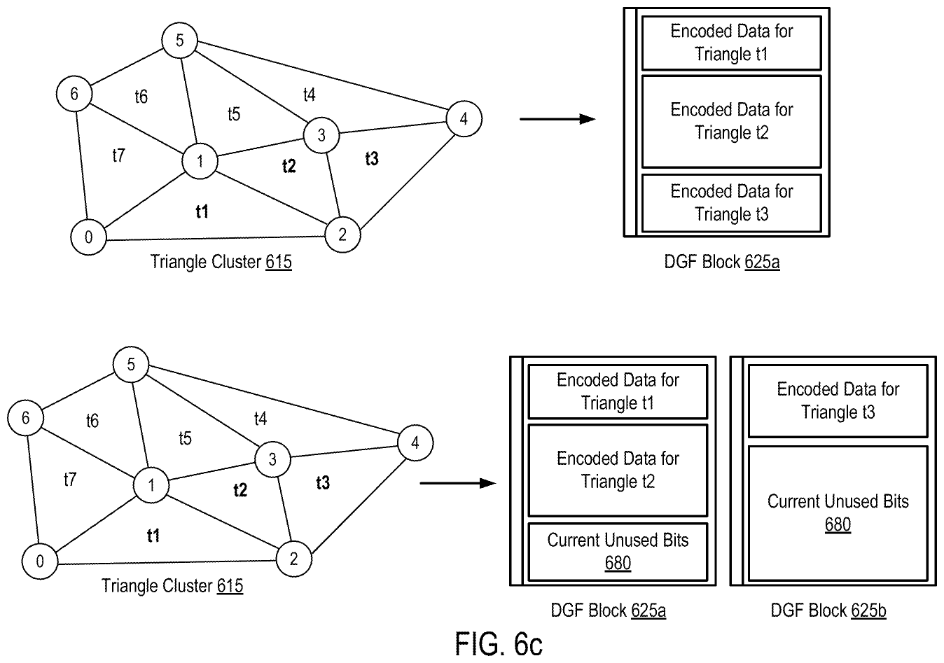

Once a second triangle is selected, the encoding circuitry generates the DGF block data from the current triangle set (i.e., the first triangle and the second triangle). When number of bits required to encode the current triangle set is less than or equal to an unused (currently available) number of bits in the DGF block, the second triangle is retained and the encoding circuitry 286 searches for another triangle in the cluster. However, if number of bits required to encode the current triangle set is greater than the current unused bits, a new DGF block is started, beginning with the unused second triangle. This process repeats until all triangles are consumed in the cluster and/or till a DGF block is full. A total number of bits available in a given DGF block can be defined based on the size of the DGF block. These and other implementations are described in detail with respect for FIGS. 6a to 6c.

The implementations described herein provide improvements over conventional formats for encoding triangle data, e.g., including using vertex and index buffers. These conventional formats often include unstructured data arrays that are not fixed in size. In such arrays, it may be harder to fetch the data, e.g., the data may be stored in different locations in the array, and these locations need to be identified first, thereby increasing processing time and cost. For instance, data can be stored in different cache lines, and multiple addresses may have to be read as more and more data is encoded. On the contrary, the DGF blocks described herein stores primitive data using granular 128-byte pieces in a structured format. This enables faster and more efficient access to data during rendering applications. Another advantage of using DGF blocks to encode triangle data is that encoded data is more tightly compressed, than formats that can be used directly for rendering, thereby saving on storage space. Further, the DGF blocks are compressed using a density that is aptly suited for rendering applications.

The implementations described herein further enable compact storage of large triangle mesh models in a form that minimizes constraints on the content authoring, and enables direct rendering using encoded primitive data. In one implementation, different types of primitives can be represented using the fixed-size data blocks, such that content creators are given fine-grained control over the compression rate to enable tradeoffs between accuracy and storage costs. In an implementation, the format of data stored in the data block can be aligned to cache lines of the GPU 205. Further, encoded data is stored in a manner that the data is amenable for direct consumption by fixed-function hardware (as opposed to compute-shader based rendering). In one implementation, compression and storage of data disclosed herein enables lossy compression with precise control over data loss and direct rendering of the compressed representation of primitive data.

FIG. 3 is an illustration of a bounding volume hierarchy (BVH), according to an implementation. For simplicity, in the exemplary implementation depicted in FIG. 3, the hierarchy is shown in two-dimension. However, in various alternate implementations, extension to three-dimension may be possible, and it should be understood that the methods described herein would generally be applicable to three-dimensional hierarchies as well.

The spatial representation 302 of the BVH is illustrated in the left side of FIG. 3 and the tree representation 304 of the BVH is illustrated in the right side of FIG. 3. In one example, the bounding volumes are represented by “N,” such that N1-N7, are distinct bounding boxes. In the example, bounding box N1 encompasses all other bounding boxes N2-N7. Further, each bounding box N2-N7 includes one or more triangles, that represent geometric objects, and are denoted by “T.” For example, bounding box N1 includes all other bounding boxes and their respective triangles T1-T8. In a similar manner, bounding box N2 includes smaller bounding boxes N5 and N4, such that N4 includes triangles T1 and T2, and N5 includes triangles T4 and T3. Further, for the sake of brevity, in the tree representation 304 the bounding boxes are each represented by a non-leaf node “N” and each triangle is represented by leaf nodes T.

In order to perform ray tracing for a scene, a processing circuitry (e.g., ray tracing circuitry 280 of FIG. 2) performs a ray intersection test by traversing through the tree 304, and, for each bounding box tested (i.e., by traversing respective internal nodes N), eliminating branches below a traversed node if the test for that node fails. In one example, it is assumed that ray 1 intersects triangle T5 as the closest hit. The processing circuitry would test against bounding box N1 and then after returning a hit, fetch the resulting child node, which contains bounding boxes for the next level of hierarchy below N1 (nodes N2 and N3). When this node data returns from memory, bounding boxes for N2 and N3 are tested. The processing circuitry returns a failure or miss result against bounding box N2 (since ray 1 does not interact with the bounding box). The processing circuitry eliminates all sub-nodes of node N2. Since ray 1 does interact with bounding box N3, it would return a hit and then subsequently fetch N3 from memory, which contains bounding boxes for N6 and N7. Tests are then performed against bounding boxes N6 and N7, by traversing through their respective representative nodes N6 and N7, noting that the test for node N6 succeeds but for node N7 fails. The processing circuitry would then test triangles T5 and T6 by traversing through representative leaf nodes T5 and T6, noting that test determines that T5 is the closest hit for the ray, and therefore the test for T5 succeeds, but T6 fails (even though the ray might hit T6, however it is not the closest hit).

In an implementation, the BVH 304 is generated using a given scene geometry. The scene geometry includes primitives that describe a scene comprising one or more geometric objects, which are provided by an application or other entity. In one implementation, software executing on a processor, such as the command processor 235, is configured to perform the functionality described herein, hard-wired circuitry configured to perform the functionality described herein, or a combination of software executing on a processor and hard-wired circuitry that together are configured to perform the functionality described herein. In various examples, the BVH 304 is constructed using one or more shader programs, such as executing on the processing circuitry, or on a hardware unit in a command processor. In various embodiments, the BVH 304 is constructed prior to runtime. In other examples, the BVH 304 is constructed at runtime, on the same computer that renders the scene using ray tracing techniques. In various examples, a driver, an application, or a hardware unit of a command processor performs this runtime rendering.

In an implementation, a data structure comprising one or more data fields, each containing information pertaining to the different nodes of the BVH 304, for which intersection testing is to be performed, is stored in a memory location accessible by the processing circuitry. For example, the data structure is stored in system memory 225 or local memory 230 (as shown in FIG. 2), such that each time a hierarchical tree is created and/or updated, the data structure is updated by the processing circuitry. An exemplary data structure includes node metadata such as, but not limiting to, node identifiers, node surface areas, node subtree information, node lock status, and node bounding boxes, etc.

In one or implementations, the BVH 304 can be formed as a combination of top level acceleration structure (TLAS) and bottom-level acceleration structure (BLAS). The TLAS (e.g. nodes N2-N7) is a hierarchical data structure that organizes a collection of BLAS representing individual geometric objects or primitives (e.g., triangles T1-T8) within a scene. The TLAS is designed for rapid traversal of rays through the scene by identifying relevant BLAS instances that may intersect with the ray. In an implementation, data pertaining to geometric primitives, e.g., to be utilized for building the BVH 304 can be provided in a pre-compressed format, such that a ray tracing application can compute compressed geometry representation and upload this data to a GPU memory for further processing.

In an implementation, pre-compressed primitive data is stored in DGF blocks. Further, before generating compressed primitive data, the primitives are clustered in a manner such that each DGF block stores data corresponding to primitives that are spatially localized in a given scene. That is, data in each DGF block corresponds to primitives that can be grouped together to represent a single node of the acceleration structure (e.g., BLAS internal node). Since the primitives are clustered before the BVH is constructed, build speed can be substantially enhanced. In an example, a predetermined number of DGF blocks (e.g., storing data for a total of 65-128 primitives) can together form a data node that represents a single BLAS internal node of the BVH. A data node reference is generated for each data node storing multiple DGF blocks, e.g., when these data nodes are created. This reference can be mapped to the BLAS node it represents. The corresponding BLAS node is then constructed based on the data node reference. This acceleration structure can further be combined with other TLAS and BLAS nodes to complete construction of the BVH.

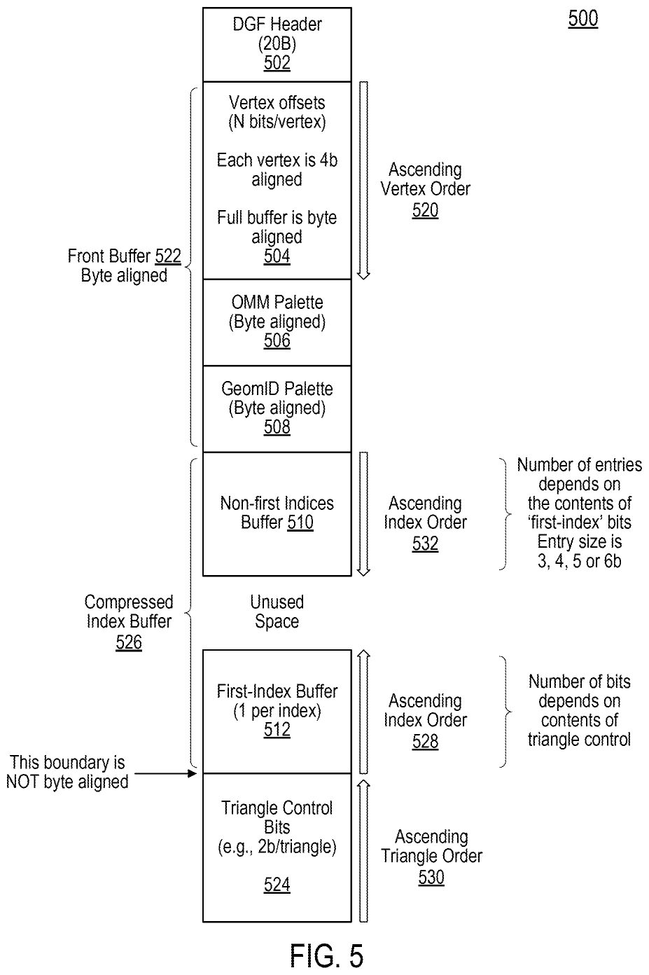

Turning now to FIG. 4, a block diagram illustrating encoding of triangle data for generation of acceleration structures has been described. As described in the foregoing, data corresponding to triangle meshes is encoded to a specific format such that the encoded data can be stored using data arrays of fixed-size data blocks (e.g., blocks of 128 bytes) to be directly consumed by a processing circuitry (e.g., GPU 205) for ray traversal or rasterization. In one or more implementations, the encoded data is generated in the form of a dense geometry format (DGF) data block (e.g., DGF block shown in FIG. 5). As described herein, a DGF data block includes various data buffers to store information pertaining to vertex indices, geometry identifiers, mesh connectivity, and opacity data pertaining to each triangle in the mesh. In one implementation, the DGF block is a fixed-size data block, e.g., consisting of an array of data blocks of 128 bytes that encode triangle data. In this example, each data block stores a maximum of 64 triangles and 64 vertices. This data structure enables partitioning triangle meshes into small, spatially localized triangle sets, and “packs” each set into a minimal number of DGF blocks (as described with respect to FIGS. 6a to 6c.

In an implementation, triangle data 420 is initially clustered (step 402) by an encoding system (e.g., encoding circuitry 286 shown in FIG. 2) using a surface area heuristic (SAH) clustering strategy for optimal ray tracing performance. Pre-clustering the geometry based on SAH accelerates the BVH build, since a BVH builder receives an efficient spatial partitioning, and does not need to construct the partitioning from the original, larger triangle set. Initially, all triangles are clustered in a single cluster representing the root of a BVH (e.g., BVH 304). A splitting plane (axis-aligned) that divides the current cluster of triangles into two sub-clusters is then chosen. In one implementation, the choice of the splitting plane is determined by evaluating different candidate planes based on the SAH. For each candidate splitting plane, the SAH cost is evaluated which considers a surface area cost and a traversal cost. The splitting plane that minimizes the SAH cost is selected and the current cluster of triangles is divided into two sub-clusters based on the selected splitting plane. Each sub-cluster will represent a child node in the BVH. This process is performed recursively for each child node (sub-cluster) until a termination condition is met (e.g., maximum depth of the BVH, minimum number of triangles per node, etc.).

In an implementation, the encoding system quantizes vertices corresponding to each triangle in each SAH cluster, e.g., to generate quantized vertices per-triangle (step 404). In one example, vertices are defined on a signed fixed-point grid to compress vertices data. For example, for quantization of data pertaining to vertices, vertices data is first defined using a 24-bit signed base position in the grid. In an implementation, a variable-width (e.g., 1-16 bits) unsigned offset for each vertex (relative to the base position) is further generated. Finally, a power-of-2 scale factor, used to map the quantization grid to floating-point coordinates for each triangle vertex, is stored as an exponent. In one example, the exponent includes floating-point representation used in the “IEEE 754 standard” for representing real numbers in computers. In this standard, a floating-point number is typically represented as a combination of three components: the sign bit, the exponent, and the significand (or mantissa). The biased exponent is a way to represent the exponent with a fixed offset that allows for various comparison and arithmetic operations. Other formats for the exponent are possible and are contemplated.

In one example, the encoding system generates a quantized vertex V_{q} based on the following exemplary sequence:

$${V}_{q} = round ( V / {2}^{e} )$$

Wherein, V is the uncompressed value of the vertex and e is the exponent, which is computed using the below exemplary sequence:

$$e = ⌈ {log}_{2} ( {E}_{0} / ( {2}^{( b - 1 )} ) - 1 ) ⌉$$

Wherein, E₀ is the maximum edge length of the bounding box over the entire model and b is a target signed bit width. As referred to herein, the ‘target signed bit width’ is a user-defined value that controls the amount of compression error. In one implementation, when encoding primitive data, an encoder attempts to fit data to compressed values which require no more than ‘b’ bits to encode. Further, the ‘maximum edge length’ is the spatial extent of the vertex positions. It is the maximum distance between any two vertices on any of the 3 coordinate axes.

In one implementation, the value of e is computed in a manner that prevents offset as well as anchor overflow. Anchor overflow may occur when a quantized vertex needs more than a given number of bits to encode (e.g., 24 bits). Similarly, offset overflow may occur when a distance of any vertex from the anchor point of a compressed block containing the vertex does not fit in a given number of bits (e.g., 16 bits). If anchor and offset overflows are not prevented, the geometry may be distorted. In one implementation, to prevent the offset overflow the value of the exponent e is computed such that it satisfies the following:

$$e \geq ⌈ {log}_{2} ( {E}_{c} ) - 16 ⌉$$

Wherein E_{c} is the maximum edge length of a given cluster's AABB. Further, to prevent overflow and underflow in the anchor fields, two additional constraints are computed, which are given by the following:

$$e \geq ⌈ {log}_{2} ( - {O}_{m i n} / ( {2}^{23} - 1 ) ) ⌉ \\ e \geq ⌈ {log}_{2} ( - {O}_{m ax} / ( {2}^{23} ) ) ⌉$$

where Oₘᵢₙ, Oₘₐₓ are minimum and maximum vertex coordinate values, respectively. In one implementation, constraints are ignored if Oₘᵢₙ is greater than 0 or Oₘₐₓ is less than 0.

The vertex quantization produces 24-bit integer coordinates for each vertex, and guarantees no more than 16-bit of difference between two vertices in the same cluster. In some implementations, the target precision can be higher than 16-bit. The 24-bit inputs are converted to offsets when DGF blocks are formed, and grouping triangles into SAH-optimized clusters facilitate keeping the offsets to a minimum. Further, exponent selection, as detailed above, may lead to precision loss when the data includes a mix of large and small triangles. In a production pipeline, this can be mitigated by subdividing large triangles, or by isolating and compressing them independently. Such implementations are contemplated.

After vertex quantization, the encoding system performs packing of DGF blocks by encoding quantized vertex data for triangles in each cluster (step 406). As used herein, packing of a data block refers to the process of organizing multiple smaller data elements into a single, larger unit to optimize memory usage, improve data alignment, or facilitate efficient processing. This technique is commonly used in computer architecture, networking, and data compression to reduce overhead and enhance performance.

In an implementation, vertex data in each cluster is encoded independently, e.g., using a greedy algorithm that tries to maximize vertex re-use for triangles in each cluster. The system begins constructing a new DGF block by arbitrarily choosing a first triangle from a given cluster. The system then searches the cluster for an unused triangle that shares the maximum number of vertices with triangles that were previously encoded using the DGF block. In one example, the encoding system selects each triangle, by accessing vertex indices from an index buffer, which defines an order in which vertices are connected to form the given triangle. The system compares the index values of vertices accessed from the index buffer, to determine shared vertices between multiple triangles.

In case more than one triangle shares the same number of vertices with previously encoded triangles in a block, Morton codes of triangle centroids are compared and a candidate triangle with the lowest Morton code is selected as the next triangle. Once such a triangle is found, vertex data for the triangle is encoded using the first fixed size data block storing previously encoded triangle data, e.g., when a number of bits required to encode data corresponding to unique vertices referenced by the triangle is lesser than a number of bits currently unused in the DGF block. If the number is greater than the currently unused bits, the triangle data is encoded using a different DGF block. This process continues till all triangles in a given cluster are processed by the system. The number of bits required to encode data for a set of triangles is determined by performing a sizing test. These implementations are further detailed in FIGS. 6a to 6c.

In an implementation, each DGF block stores vertex data of unique vertices referenced by the triangles, mesh topology as represented by triangle strips, and a compressed index buffer storing reference bits of triangle vertices. In some alternate implementations, DGF blocks also store encoded geometry identifiers. The identifiers can be encoded in two modes, i.e., a “constant mode” and a “palette mode.” In constant mode encoding, a geometry ID field in the data block stores a geometry ID and an opaque flag (indicating whether a triangle is opaque or transparent to incoming rays of light) that apply to all triangles. In palette mode, the geometry ID field is interpreted based on least significant bits (LSB) and most significant bits (MSB). The encoding system computes the bit widths of vertices, as well as bits required to store triangle topology and geometry IDs, and tests whether a given triangle set can be stored in the fixed size DGF block. If the block is full before every triangle is processed in a cluster, a new block can be created using the last unused triangle. This process continues for each triangle in the set, till all triangles are consumed.

In one example, each DGF block can store data for up to 64 triangles, whereas each data node can store data pertaining to 256 triangles, 256 vertices, and 64 materials. In one implementation, each data node corresponds to a BLAS node of a BVH. An example shown in the figure depicts a BLAS node 470 (e.g., an internal node of a BVH to be constructed) corresponding to data node 480, which stores multiple DGF block nodes 482. Further, a reference corresponding to each data node is generated, e.g., at a point when these data nodes are created. This reference can be mapped to the BLAS node the data node represents. That is, these references can be used to construct the BLAS node at the time of construction of the BVH.

As described in the foregoing, each DGF block stores encoded data pertaining to triangle mesh connectivity, i.e., topology data. According to an implementation, topology data is encoded using triangle strips. In an implementation, triangles in the mesh can be further reordered or rotated to maximize compression of mesh topology data. According to the implementation, triangles within the mesh can be reordered and triangle vertices can be rotated in a manner so as to preserve triangle winding. Preserving triangle winding in a mesh is crucial for maintaining the correct orientation of triangles, which directly affects how the mesh is rendered and shaded in computer graphics. The winding order of triangles (i.e., clockwise or counterclockwise winding) determines whether triangles are facing towards or away from the viewer, impacting visibility and rendering outcomes like shading, lighting, and culling.

The reordering of mesh topology data is performed based on a remap table 422. The remap table 422 includes a data structure to translate input values (i.e., originally generated mesh topology data) into corresponding output values (reordered mesh topology data) according to a predefined mapping. In one implementation, the remap table 422 has one entry for each triangle. Each entry stores the index of a given triangle in an input triangle ordering (0 . . . . N−1), and further stores, an index of each vertex (herein “input vertex”) that corresponds with each of the triangle's 3 vertices (0, 1, or 2). This mapping can be used to reorder the mesh topology while maintaining the original triangle ordering.

The reordering of mesh topology data is performed by the encoding system using a sideband data buffer using offline pre-processing (step 408). In an implementation, the sideband data includes an array of per-triangle elements (colors, normals, etc.). When reordering the topology, the sideband data also needs to be reordered to match the order in which triangles are connected. For each element in the sideband data, the input index from the corresponding remap table 422 entry is loaded, and a corresponding element from sideband data is mapped to the entry. Further, if the data depends on the order of the vertices in the original triangle, then the input vertex ordering from the remap table 422 is used to re-arrange it accordingly.

Based on the reordering of triangles in the mesh, the encoding system further updates corresponding index buffer data, e.g., to generate reordered buffer data 426. The next step in the process is packaging of the encoded DGF blocks 424 and the reordered buffer data 426 (step 410) to generate packaged geometric data for ray tracing and rasterization operations. The packaged geometric data undergoes processing (e.g., by a GPU or other processing circuitry) for use during runtime asset streaming (step 412), e.g., for dynamically loading and accessing geometric data into a software application or game during its execution or runtime. In an implementation, during streaming operations, the micro-BLAS nodes 480 can be accessed and processed by one or more application drivers, or hardware systems, as and when specific triangle data is required by an application (block 414). An exemplary DGF block is discussed in detail with reference to FIG. 5.

As described, when encoding triangle data using a DGF block, vertex offsets are encoded as tightly as possible, so that a minimal number of bits are expended. However, in one or more implementations, to support geometry animation, a fixed precision for every vertex may be reserved, i.e., the block is generated with a fixed bit with for each vertex. During animation, the geometry data is quantized to the selected bit width. In doing so, i.e., reserving a space in the block, can enable the vertices move around as animation is ongoing, and the coordinate values can expand and contract as necessary. An application can use a compute shader to evaluate the vertex animation, quantize the results, and pack new vertex positions into the blocks, while leaving topology and geometry IDs intact. Such implementations are possible and are contemplated.

FIG. 5 illustrates a Dense Geometry Format (DGF) block 500 for storing encoded primitive data. A DGF data block includes various data buffers that store information pertaining to vertex indices, geometry identifiers, mesh connectivity, and opacity data pertaining to each primitive in the mesh. In one implementation, the DGF block 500 is a fixed-size data block, e.g., consisting of multiple buffers storing encoded primitive data and totaling 128 bytes. In this example, the DGF block 500 stores a maximum of 64 triangles and 64 vertices. This data structure enables partitioning triangle meshes into small, spatially localized triangle sets, and “packs” each set into a minimal number of DGF blocks (as described in FIGS. 6a to 6c).

In one implementation, the first 5 Double Words (“Dwords”) of the DGF block 500 include a fixed header 502, whose structure is as shown in the figure (all bit fields are ordered from least significant bit (LSB) to most significant bit (MSB)). “Dwords” typically refer to “double words” in the context of computer memory that are units of data twice the size of a standard word. The specific size of a double word can vary depending on the computer architecture and the word size of the system. For example, on a 32-bit system, where a word is typically 32 bits (4 bytes), a Dwords would be 64 bits (8 bytes). Similarly, on a 64-bit system, where a word is 64 bits (8 bytes), a Dword would also be 64 bits (8 bytes), but the term might still be used contextually.

As shown in the figure, vertex data 504 is packed in the DGF block 500, immediately following the header 502, in an ascending vertex order 520. In one implementation, the size of each vertex is 4 byte aligned. Further, the size of the vertex data section is also byte-aligned. Pad bits can be inserted as required, and all pad bits must be zero. In an implementation, the pad bits are used to align data to byte boundaries, which reduces hardware decoding cost. As described herein a “byte-aligned” buffer refers to a region of memory where data is stored such that each data element or structure begins at an address that is a multiple of a certain byte boundary. This alignment ensures that data can be efficiently accessed by a processor, particularly on architectures that require specific alignment for optimal performance.

The block 500 further includes an optional opacity micro map (OMM) palette 506 that starts on the next byte boundary, and an optional Geometry Identifier (GeomID) palette 508 that starts on a byte boundary following the vertex data 504 and OMM palette 506. The region containing the header 502, vertex data 504, GeomID palette 508, and OMM palette 506 is referred to as the “front buffer” 522. The front buffer 522 is byte aligned, and its total size may be lesser than equal to 96 bytes, in one implementation.

As described earlier, vertices are defined on a signed 24-bit quantization grid. Vertex data 504 stores the following: a 24 bit per coordinate signed anchor position, a variable-width (1-16 bits) unsigned offset for each vertex (relative to the anchor position), a power-of-2 scale factor which is used to map from the quantization grid to floating-point world coordinates (stored as an IEEE biased exponent).

In an implementation, the DGF block 500 can support exponent values from 1 through 232. In one implementation, if a DGF block encodes an exponent value outside the supported range, all ray-triangle intersection tests against this block may have undefined results. However, ray tracing applications can ensure error-free results across blocks by selecting matching quantization factors for any two neighboring blocks. This can be done by selecting a uniform quantization factor for an entire mesh. In another implementation, combination of base position and vertex offsets during encoding can cause errors for meshes containing very large triangles. This issue can be navigated by choosing a coarser quantization factor (trading off precision), subdividing large, problematic triangles (whether automatically or manually), or reverting to uncompressed geometry for problematic assets.

As described in the foregoing, mesh topology is encoded using triangle strips. In one implementation, the order of the stored vertices is used to minimize the size of the topology encoding. That is, instead of storing data each time a new vertex is referenced for the first time, the first reference is identified by means of a counter. For encoding the mesh topology, the following are generated-triangle control bits 524 and an index buffer 526. The triangle control bits 524 include two control bits per triangle indicating a triangle's position relative to previous two triangles. Further, the length of the index buffer 526 is determined by the contents of the control bits. The index buffer 526 is further organized into two sections-a first-index buffer 512, for storing bits each representing a first reference to a given vertex in a given strip, and non-first indices buffer 510, each representing a non-first reference to a given vertex.

In one or more implementations, each control bit 524 indicates the triangle's position relative to previously identified triangles in the strip. In one implementation, the control values include ‘RESTART’ bits, ‘EDGE1’ bits, ‘EDGE 2’ bits, and ‘BACKTRACK’ bits. In one implementation, the value of the RESTART bits is 0 (bits ‘00’), and these bits are used to start a new triangle strip, specifying 3 vertex indices for a triangle. Further, the EDGE1 bits (value 1, bits ‘01’) represent reusage of a second edge of a last identified triangle as a first edge of a current triangle. Similarly, the EDGE2 (value 2, bits ‘10’) bits represent reusage of a third edge of a last identified triangle as a first edge of a current triangle.

In one implementation, the BACKTRACK bits (value 3, bits ‘11’) represent that an opposite edge of a last identified triangle's predecessor triangle is reused. In this implementation ‘opposite edge’ is given by EDGE1 bits if the last triangle used EDGE2, or EDGE2 bits if the last triangle used EDGE1. Further, backtracking is not used to form a current triangle, unless the last triangle is formed using EDGE1 or EDGE2. That is, backtracking is not used to form a current triangle, after a new strip is initiated or if the last triangle was formed using backtracking. It is noted that when an edge of a previously identified triangle is reused, the reused edge is always the first edge in the new triangle, and the other two edges connect to a new vertex, which is always the third vertex in the triangle.

In one implementation, the index buffer 526 is compressed by re-ordering vertices by first use and omitting storage of the first index to every vertex, as identified using the is-first bits. This enables calculating the first index of a given vertex, by simply using a counter, e.g., by counting the number of is-first bits that were encountered before the given vertex. In an example, a single is-first bit per index is used to indicate whether it is the first index to its corresponding vertex. In one example, the first three indices of each vertex are always ‘first references’, and therefore corresponding is-first bits for these indices need not be stored. As shown, data in the first-index buffer 512 is stored in an ascending index order 528. The control bits and is-first indices are allocated from the back of the block 500, and can make hardware decode easier because the data is indexed from a known start position, and fewer computations may be needed to locate the data for a particular triangle. Ascending order for the first-index buffer 512 renders the buffer data consistent with the vertex data (thereby avoiding storing the number of indices). Further, in an implementation, there is one index for each zero bit in the is-first bit vector. That is, the number of indices in the first-index buffer 512 is the number of zero bits in the ‘is-first’ bit vector. Indices whose ‘is-first’ bits are 1 can be calculated using counters, instead of storing them explicitly.

Further, for the non-first indices buffer 510, the number of bits per non-first index is stored in the header 502. In one example, valid values of the number of bits per non-first index can be 0, 1, 2, 3, encoding 3, 4, 5, and 6 bits, respectively. In one implementation, the total size of the first-index buffer 512 is lesser than or equal to 24 bytes. Further, the non-first indices buffer 510 is located immediately adjacent to the front buffer 522, as shown. The data in the non-first indices buffer 510 is stored in ascending vertex order 532. The triangle control bits 524 are located at the end of the DGF block 500, and the first-index buffer 512 is stored immediately in front of the triangle control bits 524. Further, boundary between compressed index buffer 526 and triangle control bits 524 may or may not be byte aligned.

In one implementation, the DGF block 500 further stores geometry identifiers (GeomID 508) and opacity micro-maps flags (OMM flags 506). GeomID 508 can be used to uniquely identify and reference specific geometric entities or elements within a scene. This identifier helps in efficiently managing and manipulating geometric data in various graphics applications. Further, OMM flags cab include Boolean or numerical values associated with materials or objects to control their opacity properties. The GeomID 508 and OMM flags 506 can be stored in two different modes, wherein the mode is selected based on a geometry ID field in the header 502. The two different modes include a constant mode and a palette mode. When the value of the field is 0, a constant mode is selected, and when the value of the field is 1, a palette mode can be chosen.

In constant mode, bit 0 of the geometry ID field 508 includes an opaque flag, and bits 1-9 store a geometry identifier. These values are used for all triangles. In this mode, no additional data are stored in the block 500, and more space is available for vertex data. In palette mode, the geometry ID field is interpreted as LSBs and MSBs. For example, LSBs (4:0) encode a GeomID prefix size in bits (5b, 0-25) and MSBs (9:5) encode a GeomID count (5b, 1-32) (1 bit is added when decoding). For instance, in palette mode, geometry ID field 508 is used to store the properties of the palette. For example, the upper bits encode the number of geometry identifiers in the palette. The lower bits hold the number of bits (out of 25) which have the same value across all IDs (those bits are stored once instead of being repeated). Further, in palette mode, a GeomID palette structure is inserted in the block (as shown by GeomID 508). The position and size of the palette structure are aligned to byte boundaries. In one implementation, pad bits can be appended as required, however all pad bits must be zero.

In one implementation, the GeomID 508 palette consists of a prefix value whose bit length is given in the 5 LSBs of the geometry ID field and a per-triangle index buffer identifying a payload to use for each triangle. The size of each index is given by ceil (log 2 (GeomID count)), where the “ceil (parameter (X)” function returns the smallest integer not less than the parameter (X). Further, an array of N-bit payloads, where N is 25−prefixSize. In an implementation, the size of the per-triangle index field is only as large as needed to index all stored values. Further, ceil (log 2 (GeomID count)) gives the number of bits needed (using the ID count, which comes from the geometry ID field 508). The LSB of each payload contains an opaque flag. The 25b GeomID and opaque flag for a given triangle are decoded by selecting a payload from the payload buffer, and concatenating it with the prefix value.

In one implementation the OMM palette 506, if present, is also byte aligned. Pad bits are inserted as required, and all such bits must be zero. The OMM palette 508 includes a “hot-patched” section, and a “pre-computed” section (not shown). The hot-patched section is patched at runtime with OMM information when an acceleration structure is constructed. The pre-computed section is computed by encoding circuitry at the time of encoding data within the DGF 500. The size and position of the hot-patched section can be exposed to one or more applications through an API. However, the precise contents of the hot patched section are not exposed. When encoding a DGF block, that is expected to be used with OMMs, the encoding circuitry reserves space for the hot-patched section, and stores the pre-computed section immediately after it. In one example, the hot-patched section contains 8 bytes, and an additional 4 bytes for each OMM descriptor. The application using the block initializes this space with zeros. The pre-computed section includes a per-triangle index indicating which OMM descriptor to use. Triangles are ordered from front to back in ascending order 530. The number of bits per index is derived from an OMM descriptor count field in the header 502. The pre-computed section is padded out to the next byte boundary, and all pad bits must be zero. In one or more implementations, unused space in the DGF block 500, e.g., resulting from OMM Palette 506 or GeomID palette 508 data not being stored and/or otherwise, can be utilized to stored additional vertices data.

FIGS. 6a to 6c illustrate a process of packing DGF blocks with encoded triangle data. As described earlier, an initial group of triangles is first divided into SAH-based clusters for efficient ray tracing. In an implementation, to facilitate both encoding density as well as ray tracing efficiency, the DGF blocks are constructed in a by optimizing for SAH at a coarse granularity, and triangle vertex reuse at a finer granularity. Using SAH-based clustering enables a fast, cluster-granular BVH build, and improves vertex compression by arranging triangles into compact spatially localized groups. Further, by reusing vertices when encoding vertex data, higher compression rates can be achieved, while at the same time providing efficient access to individual triangle data, which is crucial for efficient ray tracing support.

As shown in FIG. 6a, an encoder initially obtains vertex data 605 as well as index buffer 610 pertaining to triangles, e.g., to encode data corresponding to these triangles using one or more DGF blocks 625. In one example, the encoder 602 obtains the unencoded triangles and corresponding vertex data 605 and index buffer 610 from a memory buffer. As shown in the figure, the vertex data 605 includes a vertex index, and corresponding x, y, and z coordinate of each vertex index. In this example, seven different vertices (with vertex index 0-6) are available and each vertex has corresponding spatial coordinate stored in the vertex data 605. The received vertex data 605 may be transmitted from a geometry processing circuitry, a graphics pipeline, a memory buffer, or an external storage device. In some implementations, the vertex data 605 is retrieved from a previously stored vertex buffer object (VBO) in a GPU memory or a system memory.

In another implementation, the encoder 602 further obtains an index buffer 610 in addition to the vertex data 605. The index buffer 610 includes numerical indices that reference vertices in the vertex data 605, defining the connectivity between vertices to form triangles. As depicted, the index buffer 610 is formed by triangle indices (t1 to t7), and corresponding vertices that each triangle references. In one example, the vertex data 605 and the index buffer 610 are transmitted to the encoder 602 through a direct memory access (DMA) operation, memory-mapped input-output (MMIO), or a data streaming process.

Using the index buffer 610, the encoder 602 retrieves sets of three indices, each corresponding to a unique triangle within the geometry. Using these indices, the encoder 602 accesses the associated vertex data 605, extracting position coordinates, normals, texture coordinates, and other attributes necessary for encoding. As shown in the figure, individual triangles t1 to t7 are formed in space using coordinate data accessed from the vertex data 605 using the index buffer 610. In an implementation, the encoder 602 applies processing methods like spatial sorting, Morton-order encoding, or hierarchical processing to organize the triangles efficiently while preserving spatial locality.

Next, the encoder 602 processes these triangles 645 to perform vertex quantization at the per-triangle level. During vertex quantization, each individual triangle's vertices are mapped to a reduced-precision representation based on a localized coordinate system (as described in detail with respect to FIG. 4). In one example, this is achieved by computing a local bounding box for each triangle and encoding vertex positions relative to this box using fixed-point or lower-bit-depth floating-point values. Once triangles 645 are quantized, they are grouped into SAH-based clusters to optimize spatial organization for acceleration structures such as Bounding Volume Hierarchies (BVH) or k-d trees. The SAH cost function is evaluated for potential partitioning of the triangles 645 based on their spatial distribution. For the sake of simplicity, all triangles t1 to t7 are shown as part of a single SAH-based cluster 615. In practice, however, multiple such clusters can be generated based on the number of individual triangles 645 and their respective spatial localities corresponding to one another.

The encoder 602 processes triangles in the cluster 615 iteratively and performs sizing tests to determine a number of triangles in the cluster 615 that can be stored using a given DGF block 625. Any given DGF block 625 can include encoded vertex data 660, encoded topology 665, and GeomID 670, as well as additional triangle data as detailed in FIG. 5. The encoded vertex data 660 includes vertex offsets and a compressed index buffer. The topology 665 includes control bits each indicative of how triangles are connected to each other using a triangle strip. Further, the GeomID 670 can include identifiers that uniquely identify and reference specific geometric entities or elements within a scene.

Turning now to FIG. 6b, a process of constructing DGF blocks 625 for encoding vertex data from a triangle cluster 615 is depicted. The process includes decomposing each SAH-based cluster of triangles into one or more DGF blocks 625. In an implementation, each given cluster is encoded independently, e.g., using a greedy algorithm for maximizing vertex re-use. As shown in the example of FIG. 6b, a given cluster 615 includes multiple triangles t1 to t7. In the implementation that is shown, each triangle t shares at least one vertex with other triangles in the cluster 615, however in alternate implementations, the cluster 615 can further include triangles having all unique vertices.

The encoder 602 begins by selecting a first triangle, e.g., triangle t1 to construct a DGF block 625a. In this example, triangle t1 is comprised of vertices (0, 1, 2). In an implementation, the encoder 602 can select triangles in any arbitrary or predefined order. The encoder 602 then computes a number of bits required to encode data corresponding to the triangle t1. As described in the foregoing, the number of bits include bits for vertex offsets, compressed index buffer, control bits (i.e., topology data), and GeomID associated with the triangle t1. The number of bits can further include bits for encoding OMM palette (as described in FIG. 5). Based on the number of bits, the encoder 602 generates an intermediate state of the current DGF block 625a. As depicted, the intermediate state of the DGF block 625a stores encoded data for triangle t1. As the DGF block 625a is a fixed size block, some unused bits 680 may remain available after storing encoded data for triangle t1. As referred to herein, an “intermediate state” of a data block refers to a temporary representation of data during processing, transmission, or transformation. This concept is widely applicable in various computing contexts, such as memory operations, cryptographic algorithms, data compression, and data transfers.

As described herein, the intermediate state is generated based on vertices, indices, and geomIDs for a current triangle set. A number of bits required to encode unique references, each time a new triangle is processed, is derived from the last generated intermediate state. Further, each time a triangle is added to a DGF block, a new intermediate state is generated. If the triangle cannot be added to the existing block, i.e., the number of bits required is greater than the available unused bits in the block, a new intermediate state for a new block is generated. In an alternate implementation, the triangle can be added to an existing intermediate state of a different block. Once all triangles are consumed, final states of DGF blocks from the resulting intermediate states are generated. In an alternate implementation, the encoder may maintain only one intermediate state at a time and construct final DGF blocks as soon as the current block becomes full.

Referring again to FIG. 6b, the encoder 602 then selects another triangle from the triangle cluster 615. In the example shown in the bottom half of FIG. 6b, triangle t2 is selected as the next triangle. In an implementation, when selecting the next triangle to be processed, the encoder 602 first determines a number of vertices that each triangle in the cluster 615 shares with the triangle t1 (i.e., the triangle that has already been processed). In one example, this determination can be made based on the index buffer 610. The encoder 602 can compare entries for each triangle in the index buffer 610 with the entry of triangle t1, and compute a number of vertices that are shared by each triangle with the triangle t1. In this example, triangles t2 and t7 each share 2 vertices with triangle t1 (i.e., vertices 1, 2 and vertices 0, 1, respectively). In case of a tie, the encoder selects the triangle with the lowest Morton Code. In this example, the encoder 602 selects triangle t2.

The encoder 602 then computes a number of bits required to encode data corresponding unique vertices referenced by each of triangle t1 and triangle t2. In this example, only one unique vertex, i.e., vertex 3, is referenced by triangles t1 and t2. In one implementation, the encoder 602 computes an integer axis-aligned bounding boxes (AABB) of the vertex. The encoder 602 further computes the coordinate (x, y, z) bit widths from the AABB size. The encoder 602 then determines a mode to encode geometry data, e.g., using a palette mode or constant mode. When palette mode is selected, the encoder 602 computes the size of the palette. The encoder 602 is further configured to construct the triangle strip containing the triangles t1 and t2. In an implementation, to generate the triangle strip each triangle's vertices are ordered such that the edge between the first two vertices (i.e., edge between vertices 1 and 2) is the one that is shared between triangles t1 and t2. A 2-bit control value per triangle is then computed indicating one of the four actions to take to generate any given triangle “n.” These actions include:
RESTART (0): Consume 3 indices and restart the strip;
EDGE1 (1): Consume 1 index and re-use edge 1 of triangle n;
EDGE2 (2): Consume 1 index and re-use edge 2 of triangle n; and
BACKTRACK (3): Consume 1 index and re-use the remaining edge of triangle n.
   In one implementation, the first triangle (t1) is always a RESTART, and its control bits are omitted. Further, vertices of re-used edges are swapped on re-use to preserve winding. Mixed winding can be encoded by restarting the strip on each winding change. BACKTRACK is allowed if the predecessor used EDGE1 or EDGE2 to allow the encoding system to handle isolated triangles without restarting the strip.

The encoder 602 further computes bits required to store a compressed format of the index buffer 610. The encoder 602 finally computes the total number of bits required to encode the unique vertices, the compressed index buffer, the topology (given by the triangle strip), and the geometry IDs. The encoder 602 compares this value of required bits to the current unused buts 680 to determine whether enough space is available in the DGF block 625a to store encoded data for the triangles t1 and t2 in the same block. When enough space is available, the encoder 602 generates another intermediate state of the block 625a, now storing encoded data for triangles t1 and t2. Further, some unused bits 680 may still remain available in the block 625a, as shown. When number of bits required to store encoded data for triangle t2 is available in the current DGF block 625a, the encoder generates a triangle set and adds triangles t1 and t2 to the set. A next triangle in the cluster 615 is then selected, and this process continues till the DGF block 625a is fully consumed and/or all triangles in the cluster 615 are processed. This is further detailed in FIG. 6c.

As shown in the top half of FIG. 6c, a next triangle t3 is selected from the cluster 615. The encoder 602 computes the number of bits required to encode unique vertices (0 and 4), the compressed index buffer, the topology (given by a triangle strip of triangles t1, t2, and t3), and the geometry IDs. The required number of bits are compared with unused bits 680 that would remain after storing encoded data for triangles t1 and t2. In this example, the encoder 602 determines that there would be enough bits available in the DGF block 625a after storing encoded data for triangles t1 and t2 and therefore the encoder 602 generates another intermediate state of the block 625a with encoded data for triangles t1, t2, and t3. In this example, since no more bits are available in the current DGF block 625a, the encoder 602 generates a final state of the block 625a from its intermediate state, e.g., applying a predefined sequence of computational or logical operations to the intermediate state, wherein the sequence is configured to complete the transformation of the data block into a final state. In one or more examples, the final state is obtained by executing at least one of encoding, encryption, compression, or formatting operations on the intermediate state, wherein the resulting block 625a conforms to the DGF format, which can be directly consumed by a graphics system for rendering applications.

In another example shown in the bottom half of FIG. 6c, when the required number of bits for storing encoding data for triangle t3 is greater than unused bits 680 that would remain after storing encoded data for triangles t1 and t2, the encoder 602 constructs a second DGF block 625b to store encoded data for triangle t3. In one alternate implementation, the encoder 602 can also store encoded data for triangle t3 using an existing DGF block different than the DGF block 625a, that has sufficient storage available to store the encoded data for triangle t3.

The encoder 602 then proceeds to select more triangles from the cluster 615, and determines which triangles can be stored in these DGF blocks 625a and 625b. It is noted that for the sake of simplicity, the DGF blocks are shown as storing encoded data for two or three triangles, however, a single DGF block can store data for up to 64 triangles. Further, multiple such DGF blocks can be generated to efficiently store data for each triangle in the cluster 615. Similar processing steps can also be performed by the encoder 602 for other triangle clusters.

In one implementation, the encoder 602 retains an intermediate state for a current DGF block, so that most of the processing steps described above require only constant work for each new triangle, i.e., there is a bounded number of steps performed to add a triangle to the intermediate state of a DGF block. For example, updating a vertex set may simply require testing three entries in a bit vector and adjusting the vertex count and the AABB as required. However, triangle strip construction must be repeated each time a new triangle is encountered. That is, during DGF data block packing, recalculation of bits that are already consumed in the DGF block need not be performed every time a new triangle is processed. As used herein, “constant work” refers to an approach where the amount of computational effort required to encode data remains independent of input size.

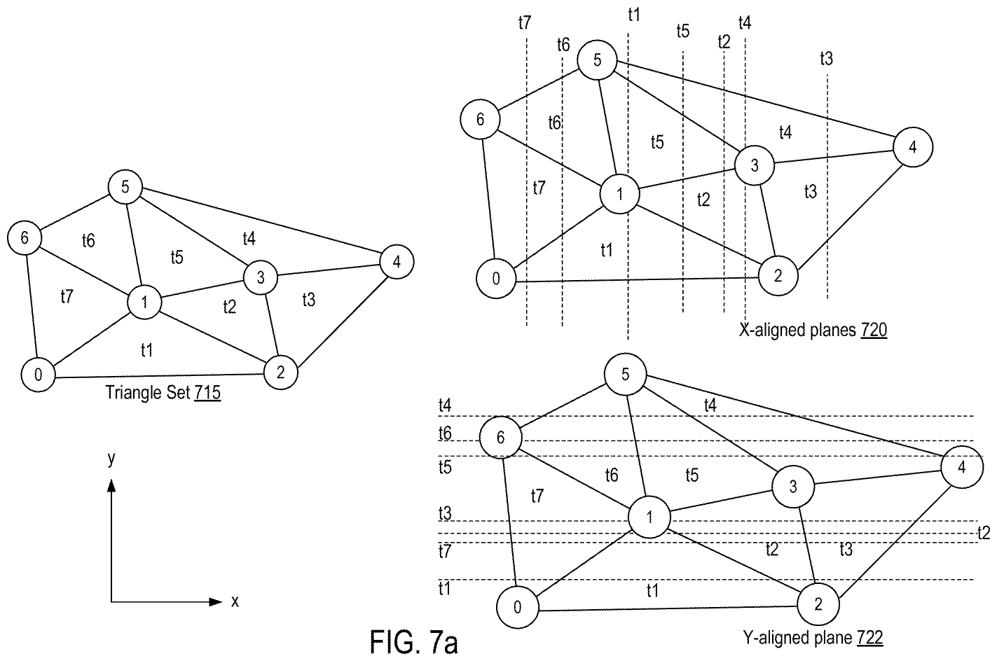

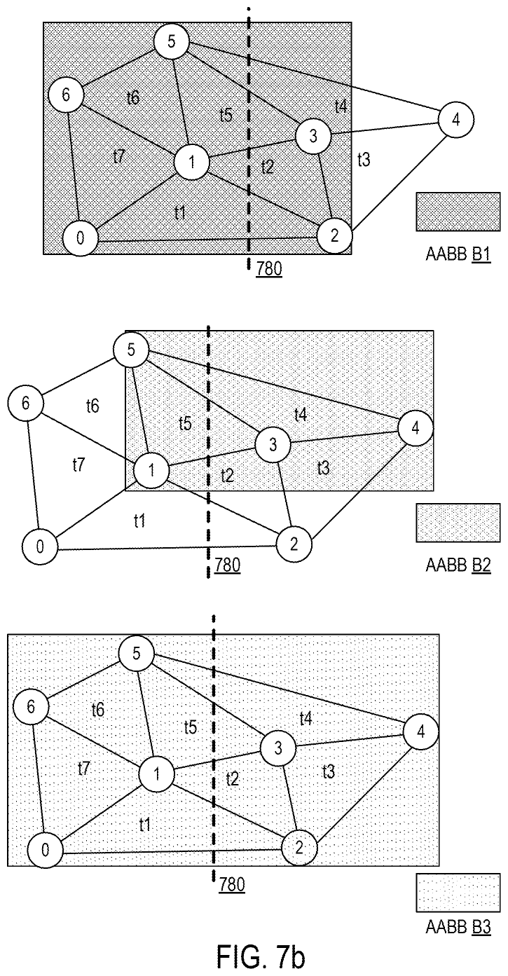

FIGS. 7a and 7b illustrate an alternate process of selecting triangles from a set of triangles to be encoded using DGF blocks. It is noted that description of FIGS. 7a and 7b is only focused on iteratively selecting triangles that are to be encoded using DGF blocks, and the description of computation of bits required to store encoded data is omitted for the sake of simplicity. The encoded data is stored in DGF blocks as described in FIGS. 6a to 6c.

Referring now to FIG. 7a, a given set of triangles 715 comprises of seven connected triangles (t1 to t7), with vertices as shown. For example, triangles t1 is formed with vertices (0, 1, 2), triangle t2 is formed using vertices (1, 2, 3), and so forth. An encoder (similar to encoder 602), when encoding triangle data using DGF blocks, first determines whether data corresponding to each triangle in the set 715 can be encoded using a single DGF block. To determine this, the encoder can perform computational steps described with reference to FIG. 6, i.e., select a first triangle to start a new DGF block, and then iteratively select more triangles till all triangles are consumed. If all triangles can be encoded using a single DGF block, the encoder proceeds to do so.

In cases where all triangles cannot be encoded using a single block, the encoder splits the triangle set 715. In an implementation, to split the set 715, the encoder selects an optimal splitting pane. To do so, a set of candidate planes are initially chosen. In the shown examples, x-aligned planes 720 and y-aligned planes 722 are generated. The x-aligned planes 720 include planes through each triangle t1 to t7, as shown. Similarly, the y-aligned planes 722 include planes through each triangle t1 to t7. In one or more implementations, for 3D processing, z-aligned planes (not shown) may also be chosen. The encoder then attempts to choose a plane with minimal processing costs from the generated planes.

In one implementation, the cost function for a candidate plane is computed using three different AABBs. This is as shown in FIG. 7b, which shows a first AABB B1 that is a bounding box of triangles on the “left” side of the triangle set 715. The second AABB B2 is a bounding box including the “right” side of the triangles in the triangle set 715. The third AABB B3 is a bounding box of the entire set 715. In the illustrated example, the first bounding box B1 includes bounding boxes for triangles t1, t5, t6, and t7. Similarly, the bounding box B2 includes bounding boxes for triangles t2, t3, and t4. Using these boxes the cost C of the splitting pane is computed as follows:

$$C = ( {n}_{B 1} * ( Area ( B 1 ) ) / ( Area ( B 3 ) ) + ( {n}_{B 2} * ( Area ( B 2 ) ) / ( Area ( B 3 ) )$$

wherein, n_{B1} and n_{B2} are number of triangles in the first bounding box B1 and second bounding box B2, respectively, and “Area (bounding box)” is the area of a given bounding box.

Based on the calculated cost, an optimal splitting plane is selected. In this example, a plane 780 through triangle t5 is selected (please refer to FIG. 7c). Using this plane 780, the triangle set 715 is split, e.g., based on a determination of which side of the plane 780 is a triangle's centroid present. In this case, a first subset is created including triangles t1, t5, t6, and t7, and a second subset includes triangles t2, t3, and t4. For each of the resulting subsets, the encoder again attempts to recursively fit the entire subset of triangles in one DGF block. If successful, the next subset is processed. If unsuccessful, the subsets may be further split. This is performed till a subset of triangles is found that can fit in a given DGF block. Once a first DGF block is consumed, the process is repeated for remaining triangles in the set 715, till all triangle data is encoded using one or more DGF blocks.

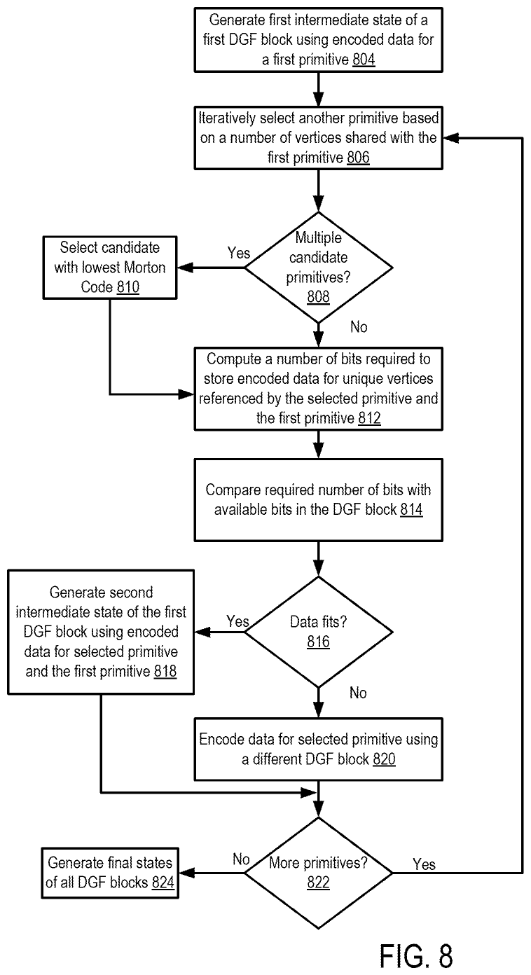

FIG. 8 illustrates a method for encoding primitive data using dense geometry format (DGF) blocks. The method begins by selecting, by an encoding circuitry (e.g., encoding circuitry 286), a first geometric primitive (e.g., triangle) from a SAH-based cluster. The encoding circuitry generates an intermediate state of a first DGF block that stores encoded data (vertices, topology, geometry ID, index buffer, etc.) associated with the first primitive (block 804). The encoding circuitry then iteratively selects another primitive, e.g., based on a number of vertices that each primitive remaining in the cluster shares with the first primitive (block 806). In this step, the encoding circuitry determines if multiple such candidate primitives are encountered (conditional block 808). If multiple candidates are encountered, i.e., more than one primitive in the cluster shares the same number of vertices with the first primitive (conditional block 808, “yes” leg), the circuitry compares Morton codes of each such primitive and selects the primitive with the lowest Morton Code (block 810). Other mechanisms for selecting candidate primitives may be possible and are contemplated. The method then continues to block 812.

However, if only a single such primitive is available (conditional block 808, “no” leg), that primitive is selected. At block 812, the encoding circuitry computes a number of bits required to store encoded data for unique vertices referenced by the first primitive and the selected primitive. The encoding circuitry then compares the required number of bits with currently available bits in the DGF block, i.e., number of bits that would be available after storing encoded data for the first primitive (block 814). Based on this comparison, the encoding circuitry determines whether encoded data for both primitives can be stored using the same DGF block (conditional block 816). If the encoded data for both primitives can be stored using the DGF block (conditional block 816, “yes” leg), the encoding circuitry generates (or adds) the first primitive and the second primitive to a primitive set (a set of primitives), and generates a second intermediate state of the first DGF block, i.e., using encoded data for the first primitive and the selected primitive (block 818). However, if encoded data for the first primitive data and the selected primitive data cannot be stored using the same DGF block (conditional block 816, “no” leg), a different DGF block (block 820) is identified. In an implementation, the different DGF block can be a new DGF block or a search for an existing DGF block having available storage that is sufficient to store the encoded data for the second primitive in addition to existing data stored in the block.

The encoding circuitry then determines if more primitives are available for processing (conditional block 822). If more primitives are available (conditional block 822, “yes” leg), the method continues to block 806, where another primitive is selected for processing. When all triangles are consumed (conditional block 822, “no” leg), final states of all DGF blocks are generated (block 824). In one implementation, these DGF blocks can be directly consumed by ray tracing systems for creation or optimization of acceleration structures such as bounding volume hierarchies.

It should be emphasized that the above-described implementations are only non-limiting examples of implementations. Numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
generate a first primitive set using a first geometric primitive and a second geometric primitive, responsive to a number of bits required to encode unique vertices of each of the first geometric primitive and the second geometric primitive being less than or equal to a number of unused bits currently available in a first fixed size data block; and
encode vertex data corresponding to the first primitive set using the first fixed size data block.

2. The apparatus as claimed in claim 1, wherein the second geometric primitive shares a maximum number of vertices with the first geometric primitive.

3. The apparatus as claimed in claim 1, wherein the number of bits required to encode the unique vertices is computed at least in part based on axis-aligned bounding boxes of the unique vertices referenced by each of the first geometric primitive and the second geometric primitive.

4. The apparatus as claimed in claim 1, wherein the circuitry is configured to:
generate one or more control bits that indicate a position of the first geometric primitive relative to the second geometric primitive; and
encode the vertex data for the first primitive set at least in part based on the one or more control bits.

5. The apparatus as claimed in claim 1, wherein responsive to the number of bits being greater than the unused bits currently available in the first fixed size block, the circuitry is configured to identify a second fixed size block to store the bits required to encode the unique vertices of each of the first geometric primitive and the second geometric primitive.

6. The apparatus as claimed in claim 5, wherein the second fixed size block is one of a new block or an existing block.

7. The apparatus as claimed in claim 5, wherein the circuitry is configured to:
generate a second primitive set at least comprising the second geometric primitive; and
encode vertex data corresponding to the second primitive set using a second fixed size data block different than the first fixed size data block.

8. The apparatus as claimed in claim 1, wherein the encoded vertex data represents at least one node of an acceleration data structure.

9. A method comprising:
generating, by processing circuitry, a first primitive set using a first geometric primitive and a second geometric primitive, responsive to a number of bits required to encode unique vertices of each of the first geometric primitive and the second geometric primitive being less than or equal to a number of unused bits currently available in a first fixed size block; and
encoding, by the processing circuitry, vertex data corresponding to the first primitive set using the first fixed size data block.

10. The method as claimed in claim 9, wherein the second geometric primitive shares a maximum number of vertices with the first geometric primitive.

11. The method as claimed in claim 9, wherein the number of bits required to encode the unique vertices is computed at least in part based on axis-aligned bounding boxes of the unique vertices referenced by each of the first geometric primitive and the second geometric primitive.

12. The method as claimed in claim 9, further comprising:
generating, by the processing circuitry, one or more control bits each indicative of a position of the first geometric primitive relative to the second geometric primitive; and
encoding, by the processing circuitry, the vertex data for the first primitive set at least in part based on the one or more control bits.

13. The method as claimed in claim 9, wherein responsive to the number of bits being greater than the unused bits currently available in the first fixed size block, the method further comprising identifying, by the processing circuitry, a second fixed size block to store the bits required to encode the unique vertices of each of the first geometric primitive and the second geometric primitive.

14. The method as claimed in claim 13, wherein the second fixed size block is one of a new block or an existing block.

15. The method as claimed in claim 13, further comprising:
generating, by the processing circuitry, a second primitive set at least comprising the second geometric primitive; and
encoding, by the processing circuitry, vertex data corresponding to the second primitive set using a second fixed size data block different than the first fixed size data block.

16. The method as claimed in claim 9, wherein the encoded vertex data represents at least one node of an acceleration data structure.

17. A processor comprising:
a memory storing a plurality of geometric primitives;
ray tracing circuitry configured to:
access data corresponding to the plurality of geometric primitives;
generate a first primitive set using a first geometric primitive and a second geometric primitive, responsive to a number of bits required to store quantized vertices unique to each of the first geometric primitive and the second geometric primitive being less than or equal to a number of unused bits currently available in a first fixed size data block;
store vertex data corresponding to the first primitive set using the first fixed size data block;
construct an acceleration data structure based at least in part on the stored vertex data; and
a plurality of compute circuits configured to render image data using the acceleration data structure.

18. The processor as claimed in claim 17, wherein the second geometric primitive shares a maximum number of vertices with the first geometric primitive amongst the plurality of geometric primitives.

19. The processor as claimed in claim 17, wherein the number of bits required to store the unique vertices is computed at least in part based on axis-aligned bounding boxes of the unique vertices referenced by each of the first geometric primitive and the second geometric primitive.

20. The processor as claimed in claim 17, wherein responsive to the number of bits being greater than the unused bits currently available in the first fixed size block, the ray tracing circuitry is configured to identify a second fixed size block to store quantized vertices unique to each of the first geometric primitive and the second geometric primitive.
